(19) United States
(12) Patent Application Publication
(10) Pub. No.: US 2013/0097274 A1
(43) Pub. Date: Apr. 18, 2013

(54) METHOD AND SYSTEM FOR MANAGING A SLAVE DEVICE THROUGH A MASTER DEVICE

(71) Applicant: People Power Company, Palo Alto, CA (US)

(72) Inventor: David Michael Moss, Palo Alto, CA (US)

(73) Assignee: PEOPLE POWER COMPANY, Palo Alto, CA (US)

(21) Appl. No.: 13/651,384

(22) Filed: Oct. 13, 2012

Related U.S. Application Data
(60) Provisional application No. 61/546,892, filed on Oct. 13, 2011.

(51) Int. Cl. G06F 15/16

(52) U.S. Cl. 709/208

(57) ABSTRACT

The invention provides a method and system for managing a slave device through a master device. The method includes downloading a control application corresponding to the slave device at the master device, wherein downloading the control application comprises retrieving a source for downloading the control application from a machine-readable code associated with the slave device. The method further includes establishing a relationship between the master device and the slave device using the control application based on a Unique Identifier (UID) associated with the slave device, wherein the UID associated with the slave device is retrieved from the machine-readable code. In addition, the method includes controlling the slave device using the control application on the master device, wherein the control application is invoked using the machine-readable code.

### FIELD OF THE INVENTION

The invention generally relates to managing networked devices, and more specifically to a method and system for managing a slave device through a master device.

### BACKGROUND OF THE INVENTION

As the price of computing falls, many devices are being connected to the internet or in other words are becoming internet-enabled. These internet-enabled ‘things’ or objects are present all around us. Further, more and more objects are becoming internet-enabled. These objects typically may not have a screen or even a physical method of input, but they may be connected, monitored, and controlled remotely through an internet connection. This revolution in computing is being called the “Internet of Things” (IoT), or equivalently, “Web of Things” (WoT).

There are fundamental out-of-box steps that a user must take to setup and manage these physical internet-connected objects.

First, a user must find and download the correct application that interfaces with the device. This application is normally manufacturer or service-provider specific and very often is executed on a mobile platform such as a cell phone or tablet computer. Without reading the installation instructions from a manual or web site, finding the correct application can be quite difficult.

Second, the user must securely bind the physical device with the user's virtual user account so that only the user or the user's group has the ability to monitor and control the device. This provisioning process may vary by manufacturer, but ultimately links a unique Identifier (ID) with the user's account. Normally this requires the user to manually type in the ID numbers or perform a more exotic method of provisioning on the device; the type most non-technical users may not easily understand how to perform.

Finally, the user needs to manage the device at run-time, which may involve locating the device in a list of many possible devices under the user's control.

There can be a lot of difficulty in identifying a device from many internet-controllable devices, each with a unique ID and even a nickname, and attempting to select the one the user may want to manage from a long list of devices associated with the user's account. With millions of objects being connected to the internet and controllable through a user interface, it is easy to understand the configuration management problem that arises when a user's or group's account is saturated with devices to choose from.

These problems currently cause negative user experiences with the out-of-box experience and run-time interaction with internet-connected objects, causing slow adoption and unhappy users.

There is therefore a need for an improved method and system for managing internet-connected objects.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram of a system for managing a slave device through a master device in accordance with various embodiments of the invention.

FIG. 2 illustrates a block diagram of the master device in accordance with various embodiments of the invention.

FIG. 3 illustrates a flow chart of a method for managing the slave device through the master device in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for managing a slave device through a master device. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a method and system for managing a slave device through a master device. The method and system described herein simplifies the process of configuring an out-of-box device such as the slave device using a machine-readable code associated with the slave device.

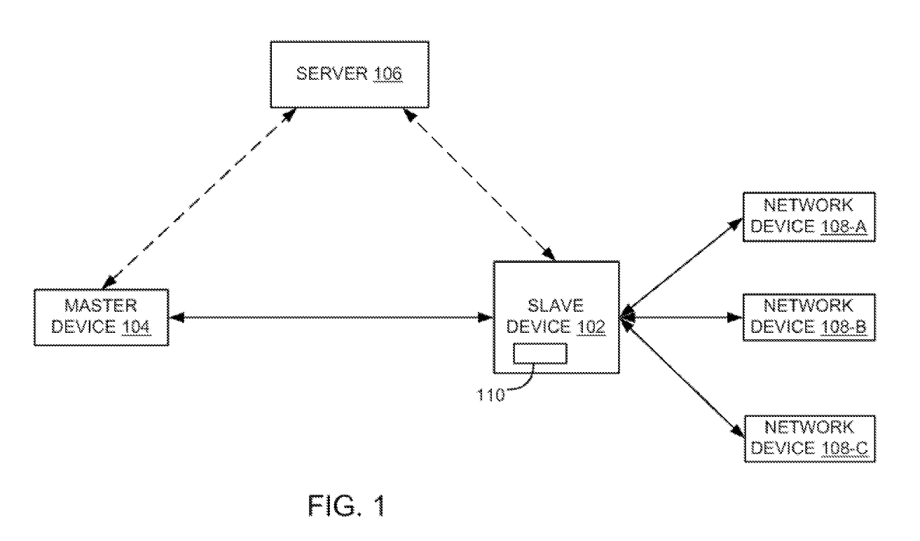

FIG. 1 illustrates a block diagram of a system 100 for managing a slave device 102 through a master device 104 in accordance with various embodiments of the invention.

As illustrated, system 100 includes slave device 102 and master device 104. In an embodiment, system 100 further includes a server 106 and one or more network devices such as, but not limited to, network device 108-A, network device 108-B and network device 108-C.

In an embodiment of the invention, slave device 102 is a device configured to be connected to a network. For example, slave device 102 can be one of, but not limited to, a refrigerator, a television, an air conditioner, an oven, a plug point, a switch, a router and a desktop that are connected to the network. In various embodiments, the network can be one or more of, but not limited to, IEEE 802.11 standards, Ethernet network, packet-based network, Bluetooth network, Ultra Wide Band (UWB) network and ZigBee network. In an exemplary embodiment of the invention, slave device 102 is an internet-connectable device.

In various embodiments of the invention, a machine-readable code 110 is associated with slave device 102. Machine-readable code 110 can be any code including information which assists in uniquely identifying slave device 102. In addition, machine-readable code 110 can include information related to slave device 102 and information that can assist in managing slave device 102. For example, machine-readable code 110 can include a source for downloading a control application for managing slave device 102. Similarly, machine-readable code 110 can include device parameters such as, but not limited to, a Unique Identifier (UID), a model number, a date of manufacture and a name of the manufacturer associated with slave device 102. In an embodiment of the invention, machine-readable code 110 includes user account credentials such as, user name and password for enabling automatic access to the user account.

In an embodiment, the UID of slave device 102 is a globally unique identifier assigned to slave device 102. It would be apparent to one of ordinary skill in the art that machine-readable code 110 can include any information which can assist in uniquely identifying and managing slave device 102.

In an embodiment of the invention, machine-readable code 110 is a Quick Response (QR) code. In another embodiment of the invention, machine-readable code 110 is a near-field communication (NFC) tag. Other examples of machine-readable code 110 include, but are not limited to, a barcode, a two-dimensional barcode, a Radio Frequency Identification (RFID) tag and other codes that can be interpreted by master device 104. It will be apparent to those ordinarily skilled in the art that machine-readable code 110 is not limited to the examples provided above and any other suitable machine-readable code can be used.

In an embodiment of the invention, one or more information in machine-readable code 110 are stored in a predefined format. For example, the one or more information associated with slave device 102 are stored in machine-readable code 110 in the format as below:
[downloadURL]?[deviceParameters/user account credentials]
   wherein the field downloadURL represents the URL where the control application is available and the field deviceParameters/user account credentials represents the parameters associated with slave device 102 such as the UID, a batch number, online user account credentials and the like.

In various embodiments of the invention, a relationship can be established between slave device 102 and master device 104 to enable management of slave device 102 through master device 104.

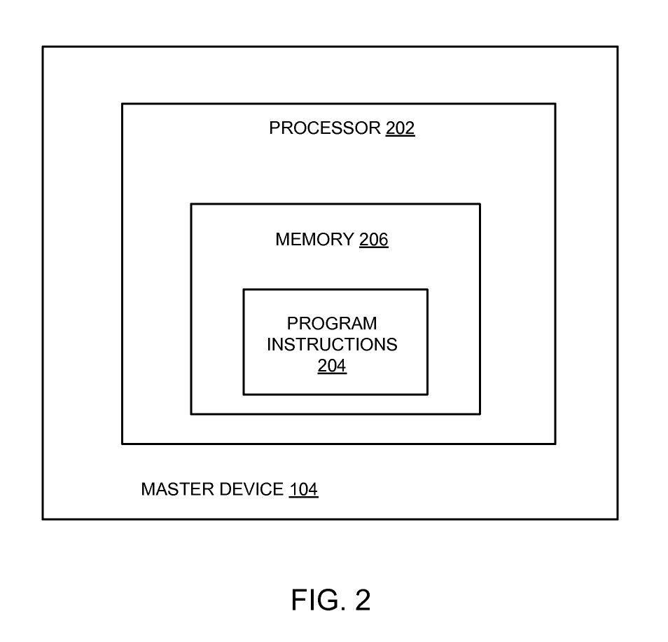

In various embodiments of the invention, master device 104 is a computing device configured to manage slave device 102. Examples of master device include, but are not limited to, a mobile phone, a smart phone, a tablet and a personal digital assistant (PDA). Master device 104 has been described in detail in conjunction with the description of FIG. 2.

In various embodiment of the invention, master device 104 is connected with slave device 102 through one or more of a wired and a wireless network such as, but not limited to, a Bluetooth network, ZigBee network, an infrared network and an UWB network for managing slave device 102. In an embodiment of the invention, master device 104 and slave device 102 interact via server 106. Server 106 can be one of, but is not limited to, a cloud server, a virtual server, and an application server. In an embodiment of the invention, server 106 includes the control application, which is accessed by master device 104 to manage slave device 102.

In various embodiments of the invention, master device 104 is configured to control slave device 102. In accordance with the various embodiments, master device 104 is configured to issue an instruction to slave device 102. In an embodiment of the invention, the instruction is issued via a control server such as server 106.

In an embodiment of the invention, master device 104 is configured to interact with various network devices via one of, the network of master device 104 and slave device 102, slave device 102 and server 106. In accordance with the embodiment of the invention, slave device 102 is configured to find a new device configured to be added to the network of slave device 102 and master device 104. For example, when a network device such as network device 108-A is added to the network of master device 104 and slave device 102, master device 104 can be used to issue an instruction to slave device 102 find whether a new device has been added to the network. Accordingly, upon receiving the instruction, slave device 102 can scan for new devices and detect that network device 108-A has been added. In an embodiment of the invention, slave device 102 is configured to detect transmission of a UID associated with the new device. Slave device 102 can be further configured to add the new device to the network of master device 104 and slave device 102.

In an embodiment of the invention, master device 104 can interact with the one or more network devices via one of the network of master device 104 and slave device 102, slave device 102 and server 106. The one or more network devices can be internet enabled and can connect to the internet using one or more of a wired and wireless connection. In an embodiment of the invention, the one or more network devices are deployed in the network of master device 104 and slave device 102.

Referring now to FIG. 2, which is a block diagram illustrating master device 104 in accordance with various embodiments of the invention. In various embodiments of the invention, master device 104 includes a processor 202. In an embodiment of the invention, processor 202 is connected with a scanner and is configured to access program instructions for scanning a machine-readable code such as machine-readable code 110 associated with a slave device such as slave device 102. In an embodiment of the invention, the scanner is a camera of master device 104. In accordance with the embodiment, the scanner is configured to scan the machine-readable code. For example, master device 104 can be a smart phone having a camera configured to scan machine-readable code 110.

In another embodiment of the invention, processor 202 includes NFC circuitry and is configured to access program instructions for detecting a NFC tag, wherein the NFC tag is associated with the slave device. In an embodiment of the invention, the NFC circuitry is a NFC chip configured to detect the NFC tag. Accordingly, processor 202 is configured to employ NFC for communicating with the machine-readable code.

In accordance with various embodiments, master device 104 further includes program instructions 204 for downloading a control application corresponding to the slave device, wherein downloading the control application includes retrieving a source for downloading the control application from the machine-readable code. In various embodiments of the invention, the control application is a set of program instructions that enables the user to configure and manage the slave device using the master device. In an embodiment of the invention, the control application is an application hosted at a server such as server 106.

Program instructions 204 also include instructions for establishing a relationship between the master device and the slave device using the control application based on a UID associated with the slave device, wherein the UID associated with the slave device is retrieved from the machine-readable code. In addition, program instructions 204 include instructions for controlling the slave device using the control application, wherein the control application is invoked using the machine-readable code. In an embodiment of the invention, program instructions 204 are embodied in the form of software. In another embodiment of the invention, program instructions 204 are embodied in a computer-readable media configured to be read by master device 104 for managing slave device 102.

In an embodiment of the invention, program instructions 204 are stored in a memory 206 of master device 104.

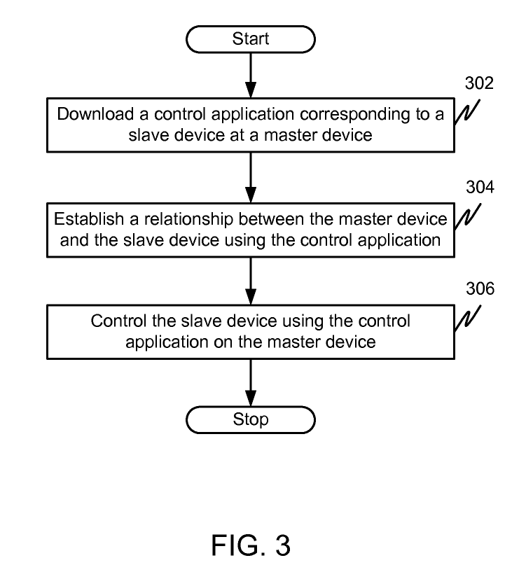

Turning now to FIG. 3, which illustrates a flow chart of a method for managing a slave device through a master device in accordance with various embodiments of the invention. The method has been described in detail in conjunction with the description of the system for managing the slave device through the master device provided hereinabove.

At step 302, a control application corresponding to the slave device is downloaded to the master device. The step of downloading the control application includes retrieving a source for downloading the control application from a machine-readable code associated with the slave device. In an embodiment of the invention, the source is a web address from where the control application is downloaded. In an embodiment of the invention, the web address is a Uniform Resource Locator (URL).

In an embodiment, retrieving the source for downloading the control application includes scanning the machine-readable code. In accordance with the embodiment, a scanner of the master device can be used for scanning the machine-readable code. In another embodiment of the invention, retrieving the source includes employing near-field communication (NFC) for communicating with the machine-readable code. In accordance with the embodiment, the processor of the master device can be used for employing NFC for communicating with the machine-readable code.

In an embodiment of the invention, retrieving the source for downloading the control application includes identifying the source from the machine-readable code at the master device. For example, a user of the master device scans the machine-readable code using the master device. Thereafter, the master device identifies the source for downloading the control application from the machine-readable code by decoding the machine-readable code.

In another embodiment of the invention, retrieving the source for downloading the control application includes transmitting the machine-readable code to a server, wherein the server retrieves the source from the machine-readable code. In accordance with the embodiment, the master device transmits the machine-readable code to the server. Thereafter, the server decodes the machine-readable code and identifies one or more information associated with the slave device from the machine-readable code. In an embodiment, the server identifies the web address for retrieving the control application from the machine-readable code. In an embodiment of the invention, the server identifies a URL in the one or more information and ignores the rest of the one or more information.

Thereafter, the server retrieves the control application from the source and transmits the control application to the master device.

At step 304, a relationship between the master device and the slave device is established using the control application based on the Unique Identifier (UID) associated with the slave device. In various embodiments, the UID is stored in the machine-readable code.

In an embodiment of the invention, establishing the relationship between the master device and the slave device includes scanning of the machine-readable code, wherein the UID is retrieved by scanning In accordance with the embodiment, the scanner of the master device can be used for scanning the machine-readable code.

In another embodiment of the invention, establishing the relationship between the master device and the slave device includes employing NFC for communicating with the machine-readable code, wherein the UID is retrieved by employing NFC. In accordance with the embodiment, the processor of the master device can be used for employing NFC for communicating with the machine-readable code.

In an embodiment of the invention, establishing the relationship between the master device and the slave device includes registering the slave device with a user account associated with the master device. It will be apparent to those ordinarily skilled in the art that the user could be logged onto the user account prior to using the machine-readable code for establishing the relationship between the master device and the slave device. Accordingly, in an embodiment, the user manually logs onto the user account and subsequently scans the machine-readable code to obtain the UID of the slave device. Thereafter, the slave device is registered with the user account using the UID obtained from the machine-readable code. In another embodiment, the machine-readable code includes the UID and user account credentials such as, user name and password for enabling automatic access to the user account. In accordance with the embodiment, the slave device is registered with the user account using the UID associated with the slave device. In an embodiment of the invention, the slave device is registered by binding the UID of the slave device with the user account. For example, the UID can be used to bind the slave device with the user account of the user of the master device. In accordance with the example, when the user scans the machine-readable code for the first time, the user is logged into the online account by extracting the one or more user account credentials. Further, the user is prompted to scan the machine-readable code for a second time in order to extract the UID and bind the slave device with the user account.

In an embodiment of the invention, the machine-readable code is transmitted to the server. Thereafter, the server extracts the user account credentials and the UID of the slave device from the machine-readable code and automatically registers the slave device with the user account.

In an embodiment of the invention, the registration of the slave device is coupled with the step of downloading of the control application from the server as explained in step 302. In an embodiment of the invention, the server retrieves the source, the UID and user account credentials when the server receives the machine-readable code for transmitting the control application to the master device. Thereafter, the server uses the UID and user account credentials to automatically register the slave device with the user account.

At step 306, the slave device is controlled using the control application in the master device. The control application is invoked using the machine-readable code.

In an embodiment of the invention, invoking the control application includes scanning the machine-readable code. In accordance with the embodiment, the scanner of the master device can be used for scanning the machine-readable code. In another embodiment of the invention, invoking the control application includes employing near-field communication (NFC) for communicating with the machine-readable code. In accordance with the embodiment, the processor of the master device can be used for employing NFC for communicating with the machine-readable code.

In an embodiment of the invention, performing one of scanning the machine-readable code and employing NFC invokes a control interface of the control application on the master device. The control interface enables the user to control the slave device. For example, the control interface enables the user to control one or more of, temperature settings of an air conditioner and display settings of a television using the master device. In an embodiment of the invention, the control interface is activated after establishing the relationship between the slave device and the master device. It will be apparent to one ordinarily skilled in the art that various slave devices can be controlled via the master device. Accordingly, the control interface that is invoked depends on the slave device being managed.

In an embodiment of the invention, controlling the slave device includes issuing an instruction to the slave device. For example, the control interface can be used by the user to issue one or more instructions to the slave device. In an embodiment of the invention, the instruction is issued via a control server. The control server can be one of, but not limited to, a cloud server, a virtual server and an application server.

In an embodiment of the invention, the instruction is an instruction for finding a new device configured to be added to the network of the master device and the slave device. In an embodiment of the invention, finding the new device includes detecting transmission of a UID associated with the new device. The UID associated with the new device can be one of, but not limited to, a Service Set Identifier (SSID) and Personal Area Network Identifier (PAN ID).

In an embodiment of the invention, controlling the slave device further includes adding the new device to the network of the master device and the slave device. The new device is added to the network of the master device and the slave device based on one of a predefined criteria and an instruction issued to the slave device for adding the new device to the network of the master device and the slave device.

In an embodiment of the invention, the predefined criteria include the slave device being configured to automatically configure the new device upon finding the new device. In another embodiment of the invention, the predefined criteria include the slave device being configured to automatically add the new device to the network of the master device and the slave device upon finding the new device.

In an embodiment of the invention, after receiving the instruction to add the new device to the network of the master device and the slave device, the slave device operates in a configuration mode. In the configuration mode, the slave device configures the new device and enables the new device to connect to the network of the master device and the slave device. Thus, the master device remotely configures the new device rather than requiring the user to configure the new device manually. In another embodiment of the invention, after receiving the instruction to add the new device, the slave device operates based on a combination of instructions transmitted from the master device and the predefined criteria. For example, when a user transmits a command to find new devices through the master device, the slave device shifts to the configuration mode based on the predefined criteria and automatically detects and configures the new devices.

In an embodiment of the invention, the method further includes controlling a newly added network device through the slave device. In accordance with the embodiment, the new device is controlled based on a controlling instruction issued to the slave device from the master device. In an embodiment of the invention, the master device directly manages the new device configured by the slave device.

The following describes an exemplary implementation of the method and system described hereinabove. In accordance with the exemplary implementation, a user scans a machine-readable code associated with a slave device (such as slave device 102 of FIG. 1) using a master device (such as master device 104, refer FIG. 1). The master device decodes the machine-readable code and obtains information stored in the machine-readable code. For example, the information can be stored in the following format:
[www.abc.com/slaveID]?[ID:12789]
   The first portion of the information includes a source, www.abc.com that is the web address for downloading the control application corresponding to the slave device. The second portion of the information includes the UID (12789) of the slave device. The machine-readable code can also include user account credentials such as username and password along with the UID of the slave device. In this case, the user is logged into the user account automatically upon scanning the machine-readable code. An example of the machine-readable code with user account credentials is as provided below:
[www.abc.com/slaveID]?[ID:12789/ username/password]

Thereafter, the master device retrieves the control application by interacting with the source. For example, the master device can automatically retrieve the control application from the source. Alternately, the master device can transmit the source information either directly or by transmitting the machine-readable code to a server. Thereafter, based on the source information, the server can identify the control application specific to the slave device that is requested by the master device and transmit the control application specific to the slave device to the master device.

Once the control application is downloaded, the user logs onto to the user account and opens the control application downloaded on the master device. When the user opens the control application, the control application prompts the user to scan the machine-readable code for registering the slave device with the user account of the user. Alternately, when the user scans the machine-readable code, the user account credentials are used to automatically log onto the user account. Subsequently, the control application binds the slave device with the user account using the UID and by applying appropriate policies created by the manufacturer of the slave device. For example, a policy might prohibit a user to register a slave device to user accounts of two different users.

Thereafter, when the user wishes the control the slave device, the user simply logs onto to the user account and opens the control application that is downloaded at the master device and transmits control instructions to the slave device using the control application. Alternately, the user scans the machine-readable code associated with the slave device. Upon scanning the machine-readable code, the control application is automatically invoked on the master device, which enables the user to control the slave device using the master device. The control application directly logs into the user account and presents the control interface of the slave device to the user. The user uses the control interface to control and manage the slave device in real-time.

The following describes an exemplary implementation of provisioning network devices using the method and system described herein above. In accordance with the exemplary implementation, one or more network devices associated with the slave device are deployed in the network of the master device and the slave device. Each network device of the one or more network devices transmits a unique identifier such as, but not limited to, a SSID, within the network in order to indicate the presence of the network device. When the user wishes to configure the network device, the user transmits an instruction “find new devices” to the slave device using the master device. Upon receiving the instruction, the slave device scans the network for new devices and detects the unique identifiers transmitted by the new devices. Thereafter, the slave device can automatically add the new devices to the network. Alternately, the slave device can transmit details regarding the new devices found to the master device based on which the user can choose to configure one or more of the new devices found by the slave device. In this embodiment, the user can use the control application to transmit instructions to switch the slave device to a configuration mode and subsequently instruct the slave device to “configure new devices”. As a result, the user remotely configures the new devices deployed in the network using the control application in the master device. The user can subsequently control the new devices through the slave device by issuing controlling instructions to the slave device.

The slave device can operate based on a combination of the instruction issued from the master device and predefined criteria. The slave device performs one or more additional functions based on the predefined criteria. For example, a slave device may have predefined criteria for automatically configuring newly added network devices upon detecting the newly added network devices. After configuring the newly added network devices, the user can use the master device to control the newly added network devices through the slave device.

Therefore, the disclosed method and system simplifies the process of provisioning and managing an out-of-box internet enabled slave device using a master device. The method and system also associates the slave device with a user account in order to provide the necessary security. In addition, the method and system enables a user to remotely configure one or more devices associated with the slave device to a network of the master device and the slave device.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing a slave device through a master device, the method comprising:
downloading a control application corresponding to the slave device at the master device, wherein downloading the control application comprises retrieving a source for downloading the control application from a machine-readable code associated with the slave device;
establishing a relationship between the master device and the slave device using the control application based on a Unique Identifier (UID) associated with the slave device, wherein the UID associated with the slave device is retrieved from the machine-readable code; and
controlling the slave device using the control application on the master device, wherein the control application is invoked using the machine-readable code.

2. The method of claim 1, wherein retrieving the source for downloading the control application comprises performing one of:
scanning the machine-readable code; and
employing near-field communication for communicating with the machine-readable code.

3. The method of claim 2, wherein retrieving the source for downloading the control application comprises identifying the source from the machine-readable code at the master device.

4. The method of claim 2, wherein retrieving the source for downloading the control application comprises transmitting the machine-readable code to a server, wherein the server retrieves the source from the machine-readable code.

5. The method of claim 1, wherein establishing the relationship between the master device and the slave device comprises performing one of:
scanning the machine-readable code; and
employing near-field communication for communicating with the machine-readable code.

6. The method of claim 5, wherein establishing the relationship between the master device and the slave device comprises registering the slave device with a user account associated with the master device, wherein the slave device is registered with the user account using the UID associated with the slave device.

7. The method of claim 1, wherein invoking the control application comprises performing one of:
scanning the machine-readable code; and
employing near-field communication for communicating with the machine-readable code.

8. The method of claim 7, wherein controlling the slave device comprises issuing an instruction to the slave device.

9. The method of claim 8, wherein the instruction is issued via a control server.

10. The method of claim 8, wherein the instruction is an instruction for finding a new device configured to be added to a network of the master device and the slave device.

11. The method of claim 10, wherein finding the new device comprises detecting transmission of a UID associated with the new device.

12. The method of claim 11 further comprising adding the new device to the network of the master device and the slave device based on one of a predefined criteria and an instruction issued to the slave device for adding the new device to the network of the master device and the slave device.

13. The method of claim 12 further comprising controlling the new device through the slave device based on a controlling instruction issued to the slave device from the master device.

14. The method of claim 1, wherein the machine-readable code is one of a quick response code and a near-field communication tag.

15. The method of claim 1, wherein the slave device is an internet connectable device.

16. A system comprising:
a slave device, wherein the slave device is associated with a machine-readable code; and
a master device configured to manage the slave device, the master device comprising:
a processor configured to perform one of:
scanning the machine-readable code; and
employing near-field communication for communicating with the machine-readable code; and
program instructions for:
downloading a control application corresponding to the slave device, wherein downloading the control application comprises retrieving a source for downloading the control application from the machine-readable code;
establishing a relationship between the master device and the slave device using the control application based on a Unique Identifier (UID) associated with the slave device, wherein the UID associated with the slave device is retrieved from the machine-readable code; and
controlling the slave device using the control application, wherein the control application is invoked using the machine-readable code.
